(19) United States
(12) Patent Application Publication
(10) Pub. No.: US 2009/0044225 A1
(43) Pub. Date: Feb. 12, 2009

(54) METHOD OF BUILDING UP GROUP PROFILE FOR CUSTOMIZING EPG VIEWING AND METHOD OF USING THE GROUP PROFILE

(75) Inventors: Chi Chia Lin, Tainan County (TW); Ching Kwei Hsu, Tainan County (TW); Chun Sung Chou, Tainan County (TW)

Correspondence Address: WPAT, PC;INTELLECTUAL PROPERTY ATTORNEYS, 2030 MAIN STREET, SUITE 1300, IRVINE, CA, 92614, US

(73) Assignee: HIMAX TECHNOLOGIES LIMITED, Tainan County (TW)

(21) Appl. No.: 11/835,284

(22) Filed: Aug. 7, 2007

(51) Int. Cl. G06F 3/00

(52) U.S. Cl. 725/46

(57) ABSTRACT

The method of building group profiles for customizing EPG viewing includes the steps of: automatically establishing background information of viewers by means of personal profiles of the viewers; and automatically establishing preference information of the viewers by means of personal profiles or browsing records of the viewers.

### BACKGROUND OF THE INVENTION

1. Field of the Invention

The present invention relates to a method of building profiles for electronic program guides (EPG), and more particularly to a method of building group profiles for customizing EPG viewing and the method of using the group profile.

2. Description of the Related Art

Digital Television (DTV) is becoming more and more popular throughout the world. In a DTV environment, the program guide is transmitted in a digital manner through a variety of channels. When a user turns on a DTV, the first thing he or she looks at is inevitably the EPG. Through the EPG, it is easier for the user to preview program content, and thus select the operations he or she needs, such as pre-programmed recording, searching, timing, scheduling and setting up system preferences.

EPG is an easily customized product that is able to offer suitable viewing information for individuals. In contrast to browsing the entire EPG, a customized EPG can save the user a lot of time. However, most EPG products focus on serving a single user, and neglect multi-user demands. In fact, there are usually many people watching TV in the living room at the same time, such as siblings, children and their parents, or friends. Therefore, it is necessary to develop a method to build group profiles for customizing EPG viewing.

Because the group profile for customizing EPG viewing is necessary for user's demand, it is important to design an effective method to solve such an issue.

### SUMMARY OF THE INVENTION

The method of building group profiles for customizing EPG viewing in accordance with an embodiment of the present invention comprises the steps of: obtaining background information of viewers if the background information exists; manually inputting the background information of the viewers or automatically creating the background information by existing personal profiles of the viewers if the background information does not exist; providing an option to manually establish preference information of the viewers; providing another option to automatically create preference data by the existing personal profiles of the viewers; and providing another option to automatically create preference data by existing browsing records of the viewers.

The method of building group profiles for customizing EPG viewing in accordance with an embodiment of the present invention comprises the steps of: automatically establishing background information of viewers by means of personal profiles of the viewers; and automatically establishing preference information of the viewers by means of personal profiles or browsing records of the viewers.

The method of using group profiles in accordance with an embodiment of the present invention comprises the steps of: establishing a group profile, wherein the group profile includes background information and preference data; automatically choosing favorite programs in accordance with the group profile; and highlighting the chosen favorite programs in the EPG.

### BRIEF DESCRIPTION OF THE DRAWING

The invention will be described according to the appended drawing in which:

FIG. 1 shows a flow chart of building group profiles for customizing EPG viewing in accordance with an embodiment of the present invention; and

FIG. 2 shows a detailed flow chart of building group profiles for customizing EPG viewing in accordance with an embodiment of the present invention.

### PREFERRED EMBODIMENT OF THE PRESENT INVENTION

Building personal profiles is a basic function of a currently used EPG. The attributes of the personal profiles include sex, age, favorite program types, favorite music, favorite actor as well as actress, locations, etc., where the favorite program types can be further divided into movie (comedy, action, horror, science-fiction, and so on), music (live concert, drama, MTV, KTV, and so on), sports (basketball, baseball, football, and so on), news (international, local, breaking news, weather, and so on), animal (ocean, land, virus, fossils, and so on), cartoon (3D animation, Disney, Japanese style, and so on), show (game, gambling, exercise). When building the personal profiles, the system will ask users to input the above attributes on the basis of individual requirements. For example, if the user favors sports programs, and is more particular to basketball, then the system will further ask the user to choose from NBA, NCAA, FIBA, and so on. Alternatively, the system can omit the above inquiry to avoid the user's impatience.

A group profile is similar to the personal profile except that the group profile includes: (1) sex: men/women/both; (2) age: such as a division of 7-15 years old (one 7 year-old, two 14 year-old and one 15 year-old), a division of 18-24 years old, a division of 27-55 years old, and so on; (3) group type: family, friend, church, classmate, colleague, and so on; (4) the number of people: the number of men, the number of women.

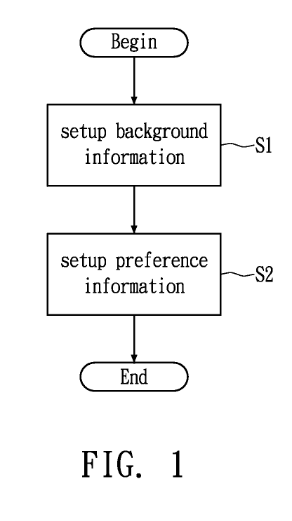

FIG. 1 shows a flow chart of building group profiles for customizing EPG viewing in accordance with an embodiment of the present invention. The flow chart is divided into two parts. The first part S1 is to generate background information, and the second part S2 is to generate preference information. Generally, the background information includes the age and sex of the viewers, and the preference information includes the favorite program type, favorite actor/actress, favorite music, and so on. Based on the background data and preference data, the group profiles are thus generated.

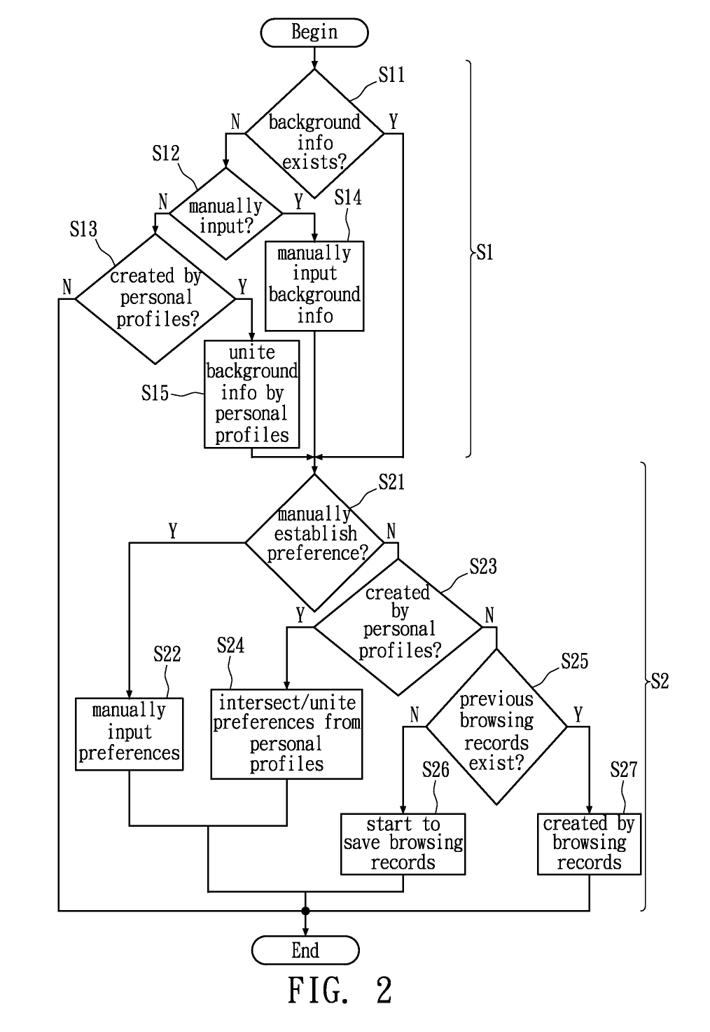

FIG. 2 shows a detailed flow chart of building group profiles for customizing EPG viewing in accordance with an embodiment of the present invention. The method of establishing background data is first to decide whether or not there is any existing background information, as shown in step S11. If so, then the process goes to the step of establishing preference information. If not, then the method inquires the user if he or she wants to manually input the background data, as shown in step S12. If the user chooses not to manually input the background data, then the method automatically creates background information by means of personal profiles of the viewers if the users notified the system in advance which users are viewing the TV, as shown in step S13. A possible method to generate the background profile is by uniting the personal profiles of the viewers, as shown in step S15. If the user chooses to manually input the background data, then the flow goes into step S13.

The method of establishing preference data is first to inquire the user if he or she wants to manually input the preference data, as shown in step S21. If the user chooses not to manually input the preference data, then the method automatically creates preference information by means of the personal profiles or the previous browsing records of the viewers, as shown in step S23. Otherwise, the flow goes into step S22. A possible method of the former is by uniting or intersecting the personal profiles of the viewers, as shown in step S24. For example, if one child likes to see movies and sports, and the other child likes to see movies and music, then a common intersection is “movies.” Furthermore, if the first child likes to see comedy movies, action movies, horror movies and science-fiction movies, and the second child likes to see comedy movies, action movies, romance movies and war movies, then a common intersection is “comedy movies and action movies.” In addition to intersection, union of personal profiles is also feasible. In the event that two close friends are able to accept the favorite of each other, a union is processed. For example, if one friend likes to see movies and music, and the other likes to see movies and sports, then the group profile covers movies, music and sports. On the other hand, if the users decide to build their group profile by browsing records, as shown in step S25, the users can indicate which group is viewing the TV, such as a specific code number which is recognized by the system. The system traces the browsing records of this group, such as a regular time for a specific program, and then generates a group profile for this group, as shown in step S27. For example, if a family used to watch the six-o'clock news and a talk show at dinner, then the favorite program is news and show, the favorite people are the reporter, the host and the invited entertainers. The more times the browsing program appears, the more accurately and completely the group profile is established. If there are no previous browsing records, the flow starts to save browsing records, as shown in step S26.

After the group profile is established, the method filters suitable programs from the EPG in accordance with the group profile. The filtered programs can be arranged in descending order in their corresponding program type or be highlighted in the EPG. For example, if the favorite programs of the group profile are sports and music, where the sport is baseball and the favorite people are Cheng-Ming Wang, Hong-Chih Kuo, Ichiro Suzuki and Alex Rodriguez, then if the system finds that ESPN is showing a live broadcast of Yankees v. Dodgers, the outing will be highlighted in the EPG, or a notice will be popped up in the EPG.

The present invention provides a method of building group profiles for customizing EPG viewing. To prevent defining too many profiles, the group profile can be created either by manual input or automatic generation. When the viewers choose to generate group profiles by automation, only the information about those persons who are currently viewing the TV needs to be input; the system will automatically generate a corresponding group profile for this group, and filter suitable programs from the EPG in accordance with the group profile.

The above-described embodiments of the present invention are intended to be illustrative only. Numerous alternative embodiments may be devised by persons skilled in the art without departing from the scope of the following claims.

What is claimed is:

1. A method of building group profiles for customizing electronic program guide (EPG) viewing, comprising the steps of:
obtaining background information of viewers if the background information exists;
manually inputting the background information of the viewers or automatically creating the background information by existing personal profiles of the viewers if the background information does not exist;
providing an option to manually establish preference data of the viewers;
providing another option to automatically create the preference data by the existing personal profiles of the viewers; and
providing another option to automatically create the preference data by existing browsing records of the viewers.

2. The method of claim 1, wherein the background information comprises the age and sex of the viewers.

3. The method of claim 1, wherein the preference information comprises favorite program type, favorite actor/actress and favorite music.

4. The method of claim 1, wherein the step of automatically creating the background information comprises uniting the personal profiles of the viewers.

5. The method of claim 1, wherein the step of automatically creating the preference information by the existing personal profiles comprises uniting or intersecting the personal profiles of the viewers.

6. The method of claim 1, wherein the step of automatically creating the preference information by the existing browsing records comprises tracing browsing records of the viewers.

7. The method of claim 6, further comprising the step of notifying a system which users are viewing in advance.

8. The method of claim 7, wherein the notification content is a code number.

9. A method of building group profiles for customizing EPG viewing, comprising the steps of:
automatically establishing background information of viewers by means of personal profiles of the viewers; and
automatically establishing preference information of the viewers by means of personal profiles or browsing records of the viewers.

10. The method of claim 9, wherein the background information comprises the age and sex of the viewers.

11. The method of claim 9, wherein the preference information comprises favorite program type, favorite actor/actress and favorite music.

12. The method of claim 9, wherein the step of automatically creating the background information comprises uniting the personal profiles of the viewers.

13. The method of claim 9, wherein the step of automatically creating the preference information by the existing personal profiles comprises uniting or intersecting the personal profiles of the viewers.

14. The method of claim 9, wherein the step of automatically creating the preference information by the existing browsing records comprises tracing browsing records of the viewers.

15. The method of claim 14, further comprising the step of notifying a system which users are viewing in advance.

16. The method of claim 15, wherein the notification content is a code number.

17. A method of using a group profile, comprising the steps of:
establishing a group profile, wherein the group profile includes background information and preference info;
automatically choosing favorite programs in accordance with the group profile; and
highlighting the chosen favorite programs in an EPG.

18. The method of claim 17, wherein the chosen favorite programs are displayed in descending order in their corresponding program type.

19. The method of claim 17, further comprising the step of popping up a notice in the EPG that a favorite program is playing.

20. The method of claim 17, wherein the group profile comprises background information and preference data of the viewers.
